(19) United States
(12) Patent Application Publication
(10) Pub. No.: US 2025/0355187 A1
(43) Pub. Date: Nov. 20, 2025

(54) METHODS TO CREATE ASYMMETRIC STRUCTURES WITH VARYING HEIGHT

(71) Applicant: Applied Materials, Inc., Santa Clara, CA (US)

(72) Inventor: Elise LAFFOSSE, Santa Clara, CA (US)

(21) Appl. No.: 19/192,673

(22) Filed: Apr. 29, 2025

Related U.S. Application Data
(60) Provisional application No. 63/647,117, filed on May 14, 2024.

(51) Int. Cl. G02B 6/34; G02B 5/18

(52) U.S. Cl. CPC G02B 6/34; G02B 5/1809; G02B 5/1857

(57) ABSTRACT

A waveguide combiner includes a substrate, a grating disposed within or over the substrate and comprising a plurality of grating structures, each of the grating structures comprising, a top surface having a top width, a first sidewall, each first sidewall of each of the grating structures having a grating height, the grating height of the first sidewall of a portion of the grating structures varies across the substrate, and a second sidewall opposing the first sidewall, the second sidewall having a blazed surface, and a linewidth disposed between the first sidewall and the second sidewall.

### CROSS-REFERENCE TO RELATED APPLICATIONS

This application claims the benefit of United Stated Provisional Patent Application Ser. No. 63/647,117 filed May 14, 2024, which is hereby incorporated by reference.

### BACKGROUND

### Field

Embodiments of the present disclosure generally relate to optical devices for augmented, virtual, and mixed reality. More specifically, embodiments described herein provide waveguide combiners including one or more gratings with asymmetric structures having varying heights and methods for forming the waveguide combiners.

### Description of the Related Art

Virtual reality is generally considered to be a computer generated simulated environment in which a user has an apparent physical presence. A virtual reality experience can be generated in 3D and viewed with a head-mounted display (HMD), such as glasses or other wearable display devices that have near-eye display panels as lenses to display a virtual reality environment that replaces an actual environment.

Augmented reality, however, enables an experience in which a user can still see through the display lenses of the glasses or other HMD device to view the surrounding environment, yet also see images of virtual objects that are generated for display and appear as part of the environment. Augmented reality can include any type of input, such as audio and haptic inputs, as well as virtual images, graphics, and video that enhances or augments the environment that the user experiences. As an emerging technology, there are many challenges and design constraints with augmented reality. Accordingly, what is needed in the art are waveguide combiners including one or more gratings with asymmetric structures having varying heights and methods for forming the waveguide combiners.

### SUMMARY

According to one or more embodiments, a waveguide combiner includes a substrate, a grating disposed within or over the substrate and comprising a plurality of grating structures, each of the grating structures comprising, a top surface having a top width, a first sidewall, each first sidewall of each of the grating structures having a grating height, the grating height of the first sidewall of a portion of the grating structures varies across the substrate, and a second sidewall opposing the first sidewall, the second sidewall having a blazed surface, and a linewidth disposed between the first sidewall and the second sidewall.

According to one or more embodiments, a method includes forming a slanted a photoresist layer over a grating layer disposed over a substrate having a first side opposing a second side, the photoresist layer having a first height that varies from the first side to the second side of the substrate and the grating layer is disposed with a second height that is consistent from the first side to the second side of the substrate, forming a slanted grating layer by etching the grating layer using the slanted a photoresist layer as an etch mask to cause the second height to vary from the first side to the second side of the substrate, and forming grating structures by etching the slanted grating layer, each of the grating structures having a grating height, the grating height of a portion of the grating structures varies across the substrate.

According to one or more embodiments, a method includes forming grating structures in a grating layer disposed over a substrate having a first side opposing a second side, the grating structures each having a grating height, the grating height is the same from the first side to the second side of the substrate, forming a slanted photoresist layer over the grating structures having a height that varies from the first side to the second side of the substrate, and etching the grating structures using the slanted photoresist layer as an etch mask, the etching of the grating structures causing the grating height of a portion of the grating structures to vary from the first side to the second side of the substrate.

According to one or more embodiments, a method includes depositing a patterned hardmask layer comprising hardmask structures having a hardmask structure height over a grating layer deposited over a substrate having a first side and a second side, forming slanted hardmask structures between each of the hardmask structures, and forming grating structures having a grating height with a portion of the grating structures having a varying grating height by etching the grating layer using the slanted hardmask structures as an etch mask.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of scope, as the disclosure may admit to other equally effective embodiments.

FIG. 1 is a schematic, frontal view of a waveguide combiner according to one or more embodiments.

FIG. 2 illustrates a flow diagram of a method for fabricating a waveguide combiner according to one or more embodiments.

FIGS. 3A-3E illustrate perspective, cross-sectional views of a grating having a first configuration during a method for fabricating the waveguide combiner according to one or more embodiments.

FIG. 4 illustrates a schematic, cross-sectional view of a grating having a second configuration according to one or more embodiments.

FIG. 5 illustrates a schematic, cross-sectional view of a grating having a third configuration according to one or more embodiments.

FIG. 6 illustrates a schematic, cross-sectional view of a grating having a fourth configuration according to one or more embodiments.

FIG. 7 illustrates a flow diagram of a method for fabricating a waveguide combiner according to one or more embodiments.

FIGS. 8A-8F illustrate schematic, cross-sectional views of a grating having a fifth configuration during a method for fabricating the waveguide combiner according to one or more embodiments.

FIG. 9 illustrates a flow diagram of a method for fabricating a waveguide combiner according to one or more embodiments.

FIGS. 10A-10G illustrate schematic, cross-sectional views of a grating having a sixth configuration during a method for fabricating the waveguide combiner according to one or more embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to optical devices for augmented, virtual, and mixed reality. More specifically, embodiments described herein provide waveguide combiners including one or more gratings with asymmetric structures having varying heights and methods for forming the waveguide combiners.

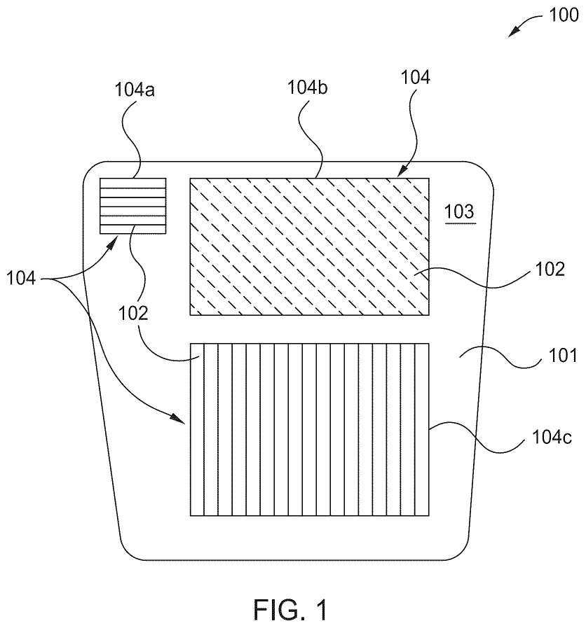

FIG. 1 is a schematic, frontal view of a waveguide combiner 100. It is to be understood that the waveguide combiner 100 described herein is an exemplary waveguide and that other waveguides may be used with or modified to accomplish aspects of the present disclosure. The waveguide combiner 100 includes a plurality of structures 102. The structures 102 may be disposed on a surface 103 of a waveguide substrate 101, or disposed in the waveguide substrate 101. The waveguide substrate 101 has a substrate refractive index (RI) n_{sub}. The waveguide substrate 101 may be formed from any suitable material, provided that the waveguide substrate 101 can adequately transmit light in a selected wavelength or wavelength range and can serve as an adequate support for the waveguide combiner 100 described herein. Substrate selection may include substrates of any suitable material, including, but not limited to, amorphous dielectrics, non-amorphous dielectrics, crystalline dielectrics, silicon oxide, polymers, and combinations thereof. In some embodiments, which may be combined with other embodiments described herein, the waveguide substrate 101 includes glass, silicon (Si), silicon dioxide (SiO₂), germanium (Ge), silicon germanium (SiGe), indium phosphide (InP), gallium arsenide (GaAs), gallium nitride (GaN), fused silica, quartz, sapphire (Al₂O₃), silicon carbide (SiC), lithium niobate (LiNbO₃), indium tin oxide (ITO), or combinations thereof. In other embodiments, which may be combined with one or more of the embodiments described herein, the waveguide substrate 101 includes high-refractive-index glass having a refractive-index greater than about 1.5. The high-refractive-index glass includes greater than 2 percent by weight of lanthanide (Ln), titanium (Ti), tantalum (Ta), or combinations thereof.

The structures 102 are nanostructures having a sub-micron critical dimension, e.g., a width less than 1 micrometer. Regions of the structures 102 correspond to one or more gratings 104. In one embodiment, which can be combined with other embodiments described herein, the waveguide combiner 100 includes at least a first grating 104a corresponding to an input coupling grating and a third grating 104c corresponding to an output coupling grating. In another embodiment, which can be combined with other embodiments described herein, the waveguide combiner 100 further includes a second grating 104b. The second grating 104b corresponds to a pupil expansion grating or a fold grating. A grating material of the structures 102 may include, but is not limited to, one or more of silicon oxycarbide (SiOC), titanium dioxide (TiO₂), silicon dioxide (SiO₂), vanadium (IV) oxide (VOx), aluminum oxide (Al₂O₃), aluminum-doped zinc oxide (AZO), indium tin oxide (ITO), tin dioxide (SnO₂), zinc oxide (ZnO), tantalum pentoxide (Ta₂O₅), silicon nitride (Si₃N₄), zirconium dioxide (ZrO₂), niobium oxide (Nb₂O₅), cadmium stannate (Cd₂SnO₄), or silicon carbon-nitride (SiCN) containing materials.

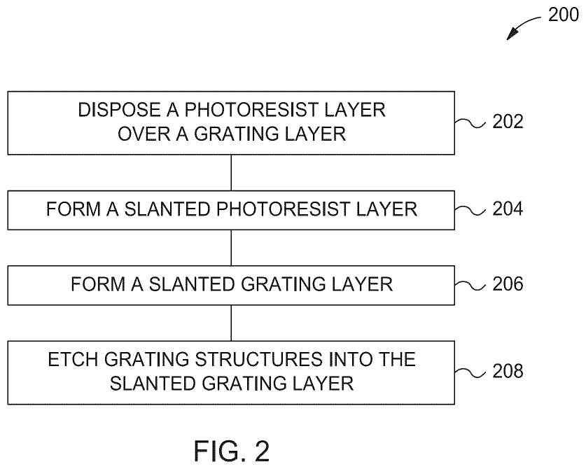

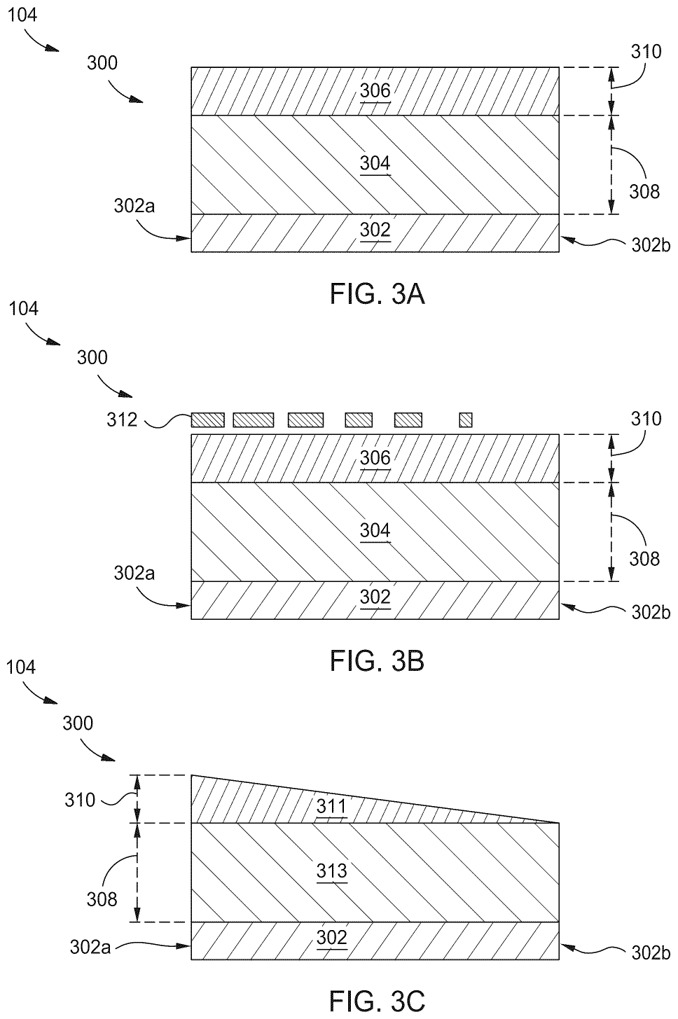

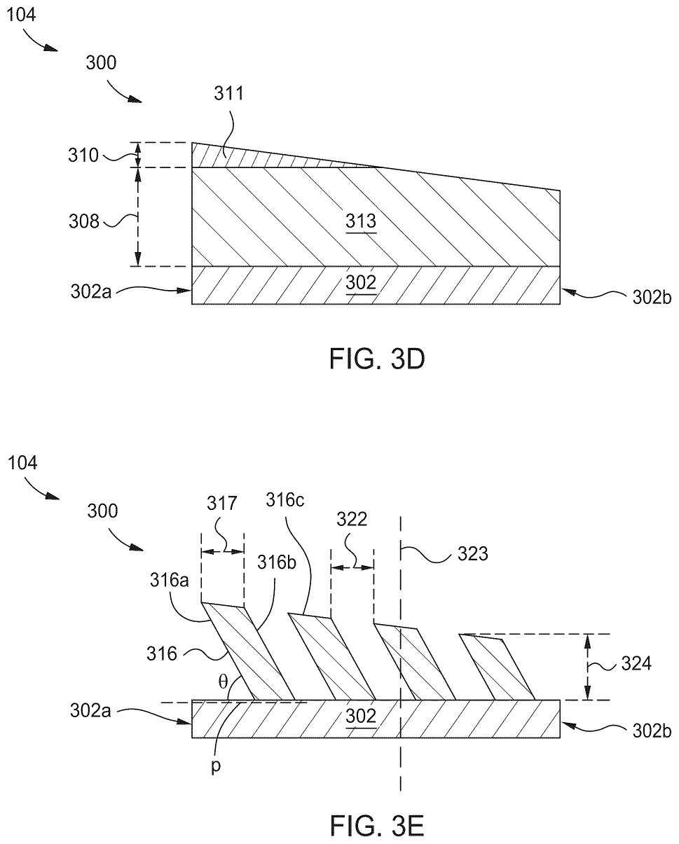

FIG. 2 illustrates a flow diagram of a method 200 for fabricating a waveguide combiner 100 according to one or more embodiments. FIGS. 3A-3E illustrate schematic, cross-sectional views of a grating 104 having a first configuration 300 during a method 200 for fabricating the waveguide combiner 100. The method 200 forms first grating structures 316 (as shown, for example, in FIG. 3E) that are asymmetric. The grating height of the first grating structures 316 change across the grating 104. One or more gratings 104, such as the first grating 104a and the second grating 104b may be formed according to the method 200.

At operation 202, and as illustrated in FIG. 3A, a first photoresist layer 306 is deposited over the grating 104. The grating 104 is in a first configuration 300. The first photoresist layer 306 may be a positive or negative photoresist layer. In some embodiments, the grating 104 may include a first grating layer 304 disposed over a first substrate 302. The first substrate 302 is the waveguide substrate 101 described in FIG. 1. The first substrate 302 may have a first side 302a that opposes a second side 302b. The first grating layer 304 may be an optically transparent material, such as silicon oxide, silicon nitride, glass, titanium dioxide (TiO₂), or other material. The first grating layer 304, prior to the deposition of the first photoresist layer 306, may have an equal height across the entire first substrate 302. For example, the first grating layer 304 may have a first height 308 that is consistent across the entire first substrate 302. The first photoresist layer 306 may be deposited over the first grating layer 304. In one or more embodiments, the first photoresist layer 306 is a photosensitive material that may be patterned by a lithography process, such as grey-tone lithography, photolithography or digital lithography, or by laser ablation process. In one embodiment, the first photoresist layer 306 is an imprintable material that can be patterned by a nanoimprint process. In one example, the first photoresist layer 306 is deposited using a spin-on coating. In one or more embodiments, the first photoresist layer 306 is deposited with a second height 310 that is the same (consistent) across the entire first substrate 302. In other embodiments, the first photoresist layer 306 may be a sacrificial hardmask layer that can be patterned.

At operation 204, and as illustrated in FIGS. 3B-3C, the first photoresist layer 306 is patterned (FIG. 3B) to form a first slanted photoresist layer 311 (FIG. 3C). The first photoresist layer 306 may be patterned in a manner such that the second height 310 varies (i.e. is different) across the first substrate 302, forming the first slanted photoresist layer 311 (FIG. 3C). For example, the first photoresist layer 306 is patterned so the second height 310 decreases from the first side 302a to the second side 302b of the first substrate 302 (or vice versa). Stated otherwise, the second height 310 changes (varies) across the grating 104.

In one or more embodiments, the first photoresist layer 306 may be patterned using a grey-tone lithography process to form the first slanted photoresist layer 311. For example, a patterned grey-tone mask 312 may be disposed over the first photoresist layer 306 (FIG. 3B). The first photoresist layer 306 may be patterned by exposing the first photoresist layer 306 through the patterned grey-tone mask 312 for a period of time, and developing the first photoresist layer 306 to remove exposed (or unexposed) portions of the first photoresist layer 306. For example, the patterned grey-tone mask 312 may be patterned to change the amount of exposure of the first photoresist layer 306 across the first substrate 302 (i.e., across the grating 104). As shown in FIG. 3B, the patterned grey-tone mask 312 may decrease the exposure of the first photoresist layer 306 from the first side 302a to the second side 302b of the first substrate 302, resulting in the first slanted photoresist layer 311 (FIG. 3C). Stated otherwise, the patterned grey-tone mask 312 and the resulting decreasing exposure of the first photoresist layer 306 causes the photoresist material removed from the first side 302a to the second side 302b of the first substrate 302 to increase (or vice versa). The increasing removal of photoresist material causes the second height 310 to decrease across the first substrate 302. In some embodiments, the first photoresist layer 306 may be patterned using an electronic beam (e-beam) process or a grey-tone ink-jet process. In other embodiments, the first slanted photoresist layer 311 may be a slanted sacrificial hardmask layer that may be directly deposited over the grating 104 using an ink-jet process (i.e., without patterning).

At operation 206, and as illustrated in FIG. 3D, the first grating layer 304 is etched using a first etching process to form a slanted grating layer 313. Stated otherwise, the first grating layer 304 is etched using the first slanted photoresist layer 311 as an etch mask to cause the first height 308 to vary across the first substrate 302 (i.e., across the grating 104). The first etching process may be any suitable etching process, including, but not limited to, ion beam etching, focused ion beam etching, electron beam etching, reactive ion beam etching, or the like.

Because the second height 310 is decreasing from the first side 302a to the second side 302b of the first substrate 302, the amount the first grating layer 304 is exposed during etching will decrease from the first side 302a to the second side 302b of the first substrate 302. The decrease in exposure will cause a decrease in etching from the first side 302a to the second side 302b of the first substrate 302. Thus, the first height 308 will decrease from the first side 302a to the second side 302b of the first substrate 302. Alternatively, as noted above, the first photoresist layer 306 can be patterned so the second height 310, and therefore, the first height 308 increases from the first side 302a to the second side 302b of the first substrate 302. As understood by those with ordinary skill in the art, during the first etching process, the first slanted photoresist layer 311 will also be etched. Therefore, thinner portions of the first slanted photoresist layer 311 may be removed, while some of the thicker portions of the first slanted photoresist layer 311 may remain. At the conclusion of operation 206 the remaining portions of the first slanted photoresist layer 311 are removed.

At operation 208, as illustrated in FIG. 3E, first grating structures 316 are etched into the slanted grating layer 313. The first grating structures 316 have a first sidewall 316a (leading sidewall) and a second sidewall 316b (trailing sidewall) and a top surface 316c having a top width 317. The first grating structures 316 may have a same or different top width 317. The first sidewall 316a and the second sidewall 316b may have the same or a different height. The first grating structures 316 may be etched into the slanted grating layer 313 using a second etching process. The second etching process may be any suitable etching process, including, but not limited to, an angled etching process, ion beam etching, focused ion beam etching, electron beam etching, reactive ion beam etching, or the like. The first grating structures 316 are angled shaped. The first grating structures 316 are angled with respect to a surface normal 323 to the first substrate 302. Each of the first grating structures 316 have a grating angle θ that may be measured with respect to a surface parallel p of the first substrate. Each of the first grating structures 316 may have a same or different grating angle θ. Also, due to the changing first height 308, the second etching process results in first grating structures 316 that have different (varying) first grating heights 324 across the first substrate 302 (i.e., across the grating 104). In some embodiments, all or some (i.e., a portion) of the first grating heights 324 may vary across the first substrate 302. The first grating height 324 may be defined as the height of the first sidewall 316a (or vice versa). In some embodiments, the first substrate 302 may act as an etch stop layer, resulting in a grating 104 having a first configuration that includes a consistent bottom profile and is also compatible with variable duty cycle (VDC) gratings. In some embodiments, each pair of first grating structures 316 may have equal or unequal first horizontal distances 322 formed between them. Although the first grating structures 316 are illustrated as angled grating structures, the first grating structures 316 may be any suitable shape. Furthermore, although the first grating heights 324 are illustrated as increasing or decreasing across the first substrate 302, all or some of the first grating heights 324 may vary in any combination across the first substrate 302.

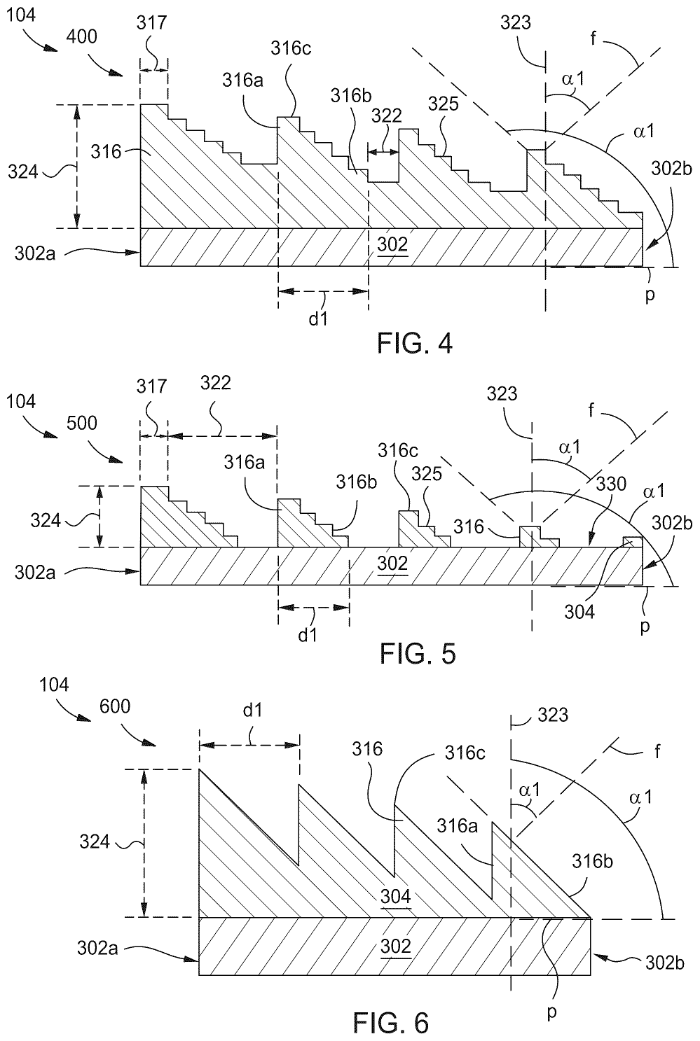

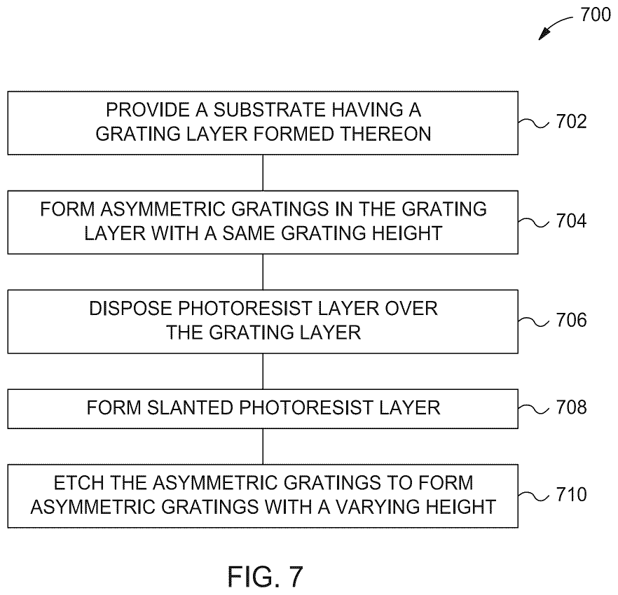

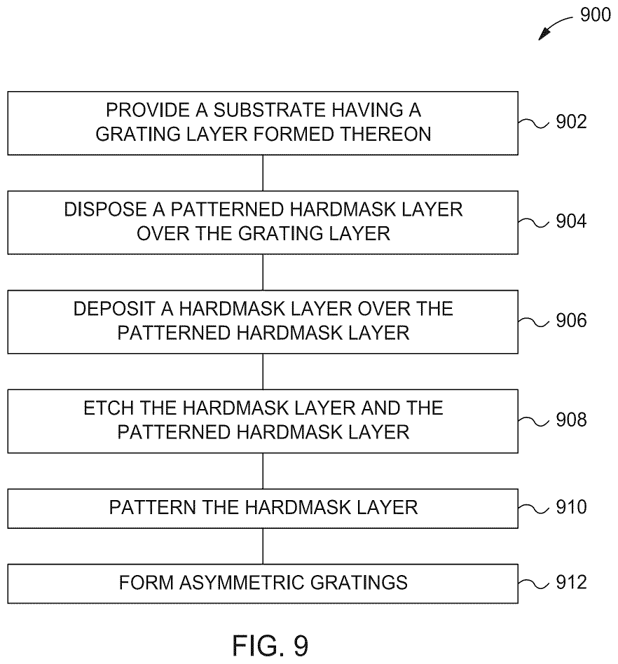

FIG. 4 illustrates a schematic, cross-sectional view of a grating 104 having a second configuration 400, according to one or more embodiments. As illustrated in FIG. 4, in the second configuration 400, the first grating structures 316 are blazed shaped (i.e. blazed grating structures) and abut each other (i.e., are jointed). In one or more embodiments, the grating 104 having the second configuration 400 is formed using method 200. The grating 104 having the second configuration 400 may also be formed using any method described herein including method 700 (FIG. 7) and method 900 (FIG. 9) described in more detail below. In the second configuration 400, the first sidewall 316a is a vertical sidewall and the second sidewall 316b has a blazed surface. The second sidewall 316b in the second configuration 400 may include at least one first step 325. Each of the first grating structures 316 may include a same quantity of first steps 325. In other embodiments, the first grating structures 316 may include a different quantity of first steps 325 (FIG. 5). The second sidewall 316b in the second configuration 400 has a first blaze angle α1. The first blaze angle α1 is the angle between the second sidewall 316b and a surface parallel p of the first substrate 302 and the angle between the surface normal 323 of the first substrate 302 and facet normal f of the second sidewall 316b. Each of the first asymmetric structures 316 may also have a first linewidth d1 in the second configuration 400. In one embodiment, which can be combined with other embodiments described herein, the first linewidth d1 of two or more the first asymmetric structures 316 are the same. In other embodiments, the first linewidths d1 may be different. For example, the first linewidth d1 of the first grating structures 316 may change (vary) across the grating 104 by decreasing (or increasing) from the first side 302a to the second side 302b of the first substrate 302 (FIG. 5). In another embodiment, which can be combined with other embodiments described herein, the first linewidth d1 of one or more the first grating structures 316 is the same (i.e., do not vary). The first grating structures 316 that are blazed and have at least one first step 325 are formed using several different lithography process and etch processes in combination with any method described herein.

In the same manner described above, each of the first grating structures 316 may have a first grating height 326 that is equal to the height of the first sidewall 316a. Each of the first grating structures 316 have a different (varying) first grating height 324. As described above, the first grating height 324 of the first grating structures 316 may be different by decreasing (varying) from the first side 302a to the second side 302b of the first substrate 302. In other embodiments, the first grating height 324 may increase from the first side 302a to the second side 302b of the first substrate 302.

FIG. 5 illustrates a schematic, cross-sectional view of a grating 104 having a third configuration 500 according to one or more embodiments. As illustrated in FIG. 5, in the third configuration 500, the first grating structures 316 are blazed shaped (i.e. blazed grating structures) and are disjointed. Stated differently, exposed portions 330 of the first substrate 302 are disposed between pairs of the first grating structures 316 in the third configuration 500. One or more characteristics (e.g., the first line width d1, the first horizontal distance 322, the quantity of first steps 325, or the like) of the first grating structures 316 may vary across the first substrate 302 along with the first grating height 326. In the third configuration 500, the first grating height 324, the first linewidth d1, the first horizontal distance 322, and the quantity of first steps 325, all vary (are different) from the first side 302a to the second side 302b of the first substrate 302. Stated otherwise, the first linewidth d1, the first horizontal distance 322, and quantity of first steps 325 all may each decrease (or increase) along with the first grating height 324 from the first side 302a to the second side 302b of the first substrate 302. In other embodiments, the first grating height 324, the first linewidth d1, the first horizontal distance 322, and/or the quantity of first steps 325 of one or more (i.e., a portion) of the first grating structures 316 are the same. In one or more embodiments, the grating 104 having the third configuration 500 is formed using method 200. The grating 104 having the third configuration 500 may also be formed using any method described herein including method 700 (FIG. 7) and method 900 (FIG. 9) described in more detail below. As noted above, the first grating structures 316 that are blazed and disjointed are formed using several different lithography process and etch processes in combination with any method described herein.

FIG. 6 illustrates a schematic, cross-sectional view of a grating 104 in a fourth configuration 600, according to one or more embodiments. As illustrated in FIG. 6, in the fourth configuration 600, the first grating structures 316 are blazed shaped (i.e. blazed grating structures), are jointed, and have a pointed top surface 316c. In the fourth configuration 600, the second sidewall 316b does not include steps. In the fourth configuration 600, the first grating height 324 varies (changes) across the grating 104. Stated otherwise, the first grating height 324 decreases (or increases) from the first side 302a to the second side 302b of the first substrate 302. In one or more embodiments, the grating 104 having the fourth configuration 600 is formed using method 200. The first grating structures 316 that are blazed and jointed (without steps) are formed using an etch tool with an ion beam directed towards the substrate 302 at an angle instead of perpendicular to the substrate 302. The grating 104 having the fourth configuration 600 may also be formed using any method described herein including method 700 (FIG. 7) and method 900 (FIG. 9) described in more detail below. As noted above, in some embodiments, all or some (i.e., a portion) of the first grating heights 324 may vary across the first substrate 302.

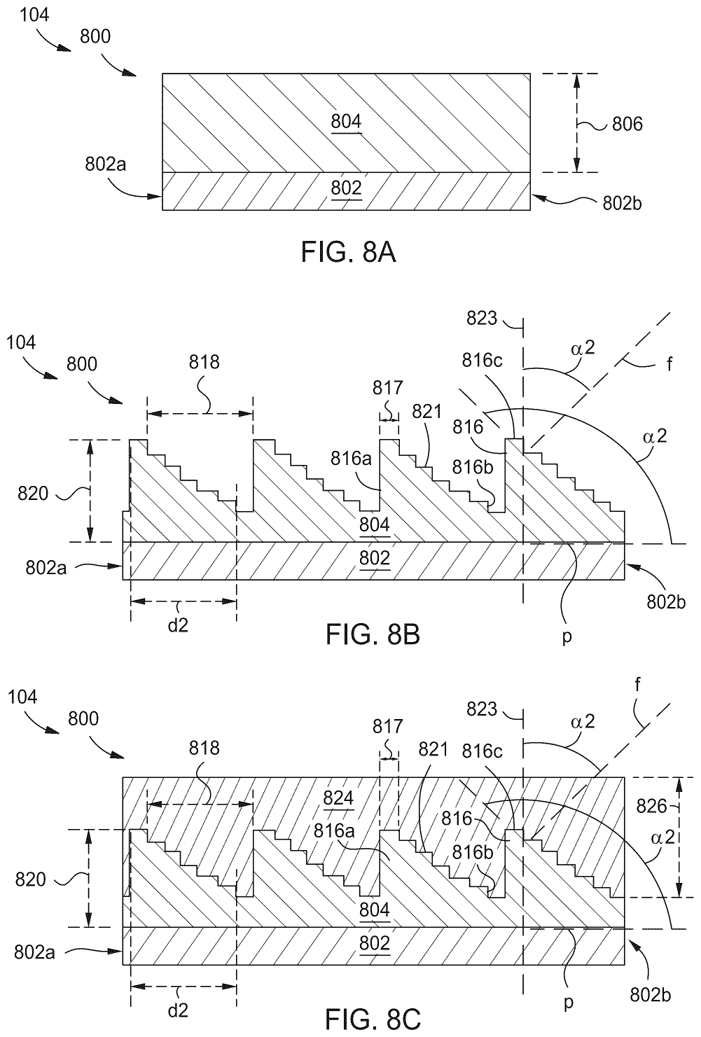

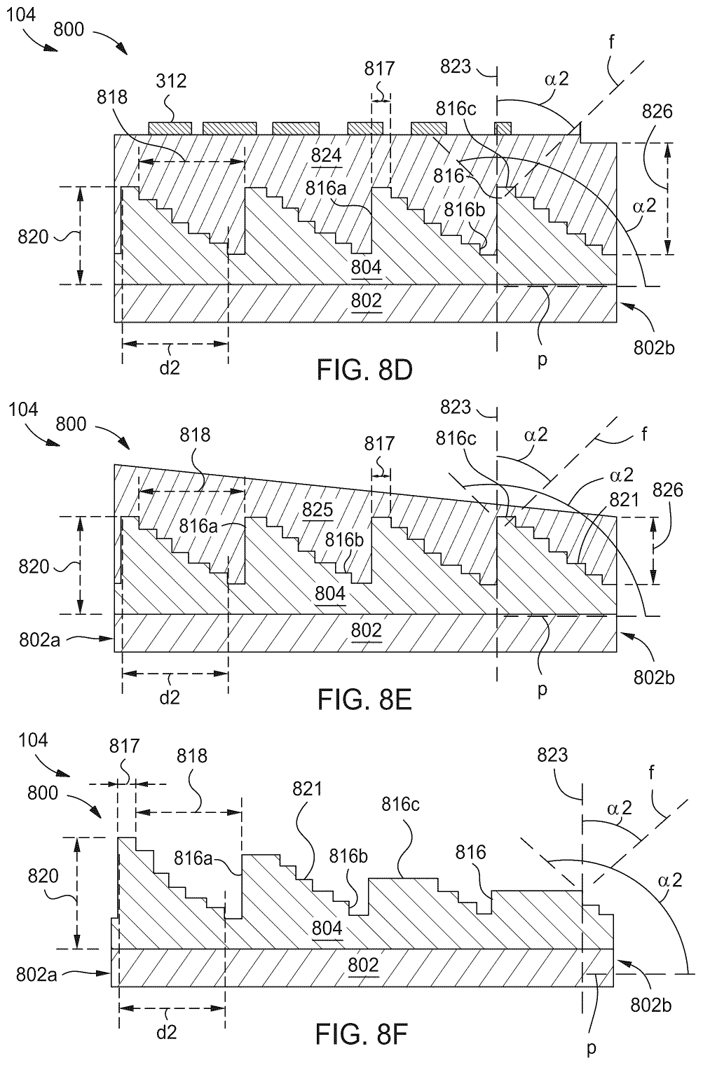

FIG. 7 illustrates a flow diagram of a method 700 for fabricating a waveguide combiner 100 according to one or more embodiments. FIGS. 8A-8F illustrate schematic, cross-sectional views of a grating 104 having a fifth configuration 800 during a method 700 for forming a waveguide combiner 100. The method 700 forms second grating structures 816 that are asymmetric. The grating height of the second grating structures 816 change across the grating 104. One or more gratings 104, such as the first grating 104a and the second grating 104b may be formed according to the method 700.

At operation 702, and as illustrated in FIG. 8A, a grating 104 in a fifth configuration 800 is provided. The grating 104 in the fifth configuration 800 includes a second grating layer 804 formed over a second substrate 802. The second grating layer 804 may be disposed from a first side 802a to a second side 802b of the second substrate 802. In some embodiments, the second substrate 802 is the waveguide substrate 101 described in FIG. 1. The second grating layer 804 may be an optically transparent material, such as silicon oxide, silicon nitride, glass, TiO₂, or other material. The second grating layer 804 may have a third height 806 that is consistent across the entire second substrate 802 (i.e., from the first side 802a to the second side 802b).

At operation 704, and as illustrated in FIG. 8B, second grating structures 816 are etched into the second grating layer 804. In one or more embodiments, the second grating structures 816 are formed by depositing a photoresist layer (not shown) over the second grating layer 804, patterning the photoresist layer, and etching the second grating layer 804 using the photoresist layer as an etch mask. The second grating layer 804 may be etched using any suitable etching process, including, but not limited to, ion beam etching, focused ion beam etching, electron beam etching, reactive ion beam etching, or the like. The second grating structures 816 may have any suitable shape. The second grating structures 816 have a first sidewall 816a and a second sidewall 816b, second grating height 820, a top surface 816c having a top width 817, and a second linewidth d2. The second grating height 820 is equal to the height of the second sidewall 816b. The second linewidth d2 is equal to the distance between the first sidewall 816a and the second sidewall 816b of the second grating structures 816.

The second sidewall 816b may have a blazed surface including second steps 821. Each of the second grating structures 816 include a same quantity of second steps 821. The second sidewall 816b has a second blaze angle α2. The second blaze angle α2 is the angle between the second sidewall 816b and a surface parallel p of the second substrate 802 and the angle between a surface normal 823 of the second substrate 802 and facet normal f of the second sidewall 816b. Due to the consistent third height 806 of the second grating layer 804, the second grating structures 816 each have an equal (consistent) quantity of second steps 821, second blaze angle α2, second linewidth d2, and second grating height 820. The second grating structures 816 may have a second horizontal distance 818 measured between adjacent second grating structures 816. The second horizontal distance 818 between different pairs of second grating structures 816 the same across the second substrate 802. In other embodiments, the second grating structures 816 may have any suitable shape such as angled shaped (FIG. 3E), disjointed blaze shape with steps (FIG. 5), or blaze shaped without steps (FIG. 6) so long as the second grating height 820 is consistent.

At operation 706, and as illustrated in FIG. 8C, a second photoresist layer 824 may be deposited over the grating 104 in the fifth configuration 800 (i.e., the second grating structures 816). The second photoresist layer 824 may be a positive or negative photoresist layer. The second photoresist layer 824 may be deposited over the second grating layer 804 and fill the spaces between the second grating structures 816. In one or more embodiments, the second photoresist layer 824 is a photosensitive material that may be patterned by a lithography process, such as grey-tone lithography, photolithography or digital lithography, or by laser ablation process. In one embodiment, the second photoresist layer 824 is an imprintable material that can be patterned by a nanoimprint process. In one example, the second photoresist layer 824 is formed using a spin-on coating. In one or more embodiments, the second photoresist layer 824 is deposited with a fourth height 826 that is the same (consistent) across the entire second substrate 802 (i.e., the grating 104).

At operation 708, and as illustrated in FIGS. 8D-8E, the second photoresist layer 824 is patterned to form a second slanted photoresist layer 825 (FIG. 8E). In one or more embodiments, the second photoresist layer 824 is patterned using any suitable patterning process. The second photoresist layer 824 may be patterned in a manner such that the fourth height 826 changes across the second substrate 802, forming the second slanted photoresist layer 825 (FIG. 8E). For example, the second photoresist layer 824 is patterned so the fourth height 826 decreases from the first side 802a to the second side 802b of the second substrate 802 (or vice versa). Stated otherwise, the second photoresist layer 824 is patterned so that it is slanted (or sloped) and the fourth height changes across the grating 104. In other embodiments, the second slanted photoresist layer 825 may be a slanted sacrificial hardmask layer that may be directly deposited over the grating 104 in the fifth configuration 800 using an ink-jet process (i.e., without patterning).

In one or more embodiments, the second photoresist layer 824 may be patterned using a grey-tone lithography process to form the second slanted photoresist layer 825. For example, as illustrated in FIG. 8D, the patterned grey-tone mask 312 may be disposed over the second photoresist layer 824. The second photoresist layer 824 may be patterned by exposing the second photoresist layer 824 through the patterned grey-tone mask 312 for a period of time, and developing the second photoresist layer 824 to remove exposed (or unexposed) portions of the second photoresist layer 824. For example, the patterned grey-tone mask 312 may be patterned to change the amount of exposure of the second photoresist layer 824 across the second substrate 802. As shown in FIG. 8D, the patterned grey-tone mask 312 may decrease the exposure of the second photoresist layer 824 from the first side 802a to the second side 802b of the second substrate 802, forming the second slanted photoresist layer 825 (or vice versa). Stated otherwise, the patterned grey-tone mask 312 and the resulting decreasing exposure of the second photoresist layer 824 causes the photoresist material removed (etched) from the first side 802a to the second side 802b of the second substrate 802 to increase (or vice versa). The increasing removal of photoresist material causes the fourth height 826 to decrease across the second substrate 802 (i.e., the grating 104) forming the second slanted photoresist layer 825 (or vice versa). In other embodiments, the second photoresist layer 824 may be patterned using an electronic beam (e-beam) process or a grey-tone ink-jet process.

At operation 710, and as illustrated in FIG. 8F, the second grating layer 804 (the second grating structures 816) are etched using the second etching process. The second etching process may be any suitable etching process, including, but not limited to, ion beam etching, focused ion beam etching, electron beam etching, reactive ion beam etching, or the like. The second slanted photoresist layer 825 may be used as an etch mask to cause the at least the second grating height 820 to vary. Stated otherwise, the second grating structures 816 are etched so that the second grating height 820 now varies from the first side 802a to the second side 802b of the second substrate. Stated otherwise, because the fourth height 826 is decreasing from the first side 802a to the second side 802b of the second substrate 802, the amount the second grating layer 804 (i.e., each of the second grating structures 816) is exposed will decrease from the first side 802a to the second side 802b of the second substrate 802. The decrease in exposure will cause a decrease in etching from the first side 802a to the second side 802b of the second substrate 802. Thus, the second grating height 820 will decrease from the first side 802a to the second side 802b of the second substrate 802. Alternatively, as noted above, the second photoresist layer 824 can be patterned so the fourth height 826 increases across the second substrate 802, and therefore, the second grating height 820 would increase from the second side 802b to the first side 802a of the second substrate 802. In some embodiments, all or some (i.e., a portion) of the second grating heights 820 may vary across the second substrate 802. Although the second grating heights 820 are described as increasing or decreasing across the second substrate 802, all or some of the second grating heights 820 may vary in any combination across the second substrate 802.

Furthermore, due to the changes in exposure from the first side 802a to the second side 802b of the second substrate 802 other attributes of the second grating structures 816 may be varied (different) from the first side 802a to the second side 802b of the second substrate 802 (i.e., across the grating 104). In one or more embodiments, any combination of the second grating angle α2, the top width 817, the second linewidth d2, the quantity of second steps 821 and/or the second horizontal distance 818 may vary (increase or decrease) across the second substrate 802. As illustrated in FIG. 8F, each of the second grating angle α2, the top width 817, the second linewidth d2, the quantity of second steps, and the second horizontal distance 818 decrease along with the second grating height 820.

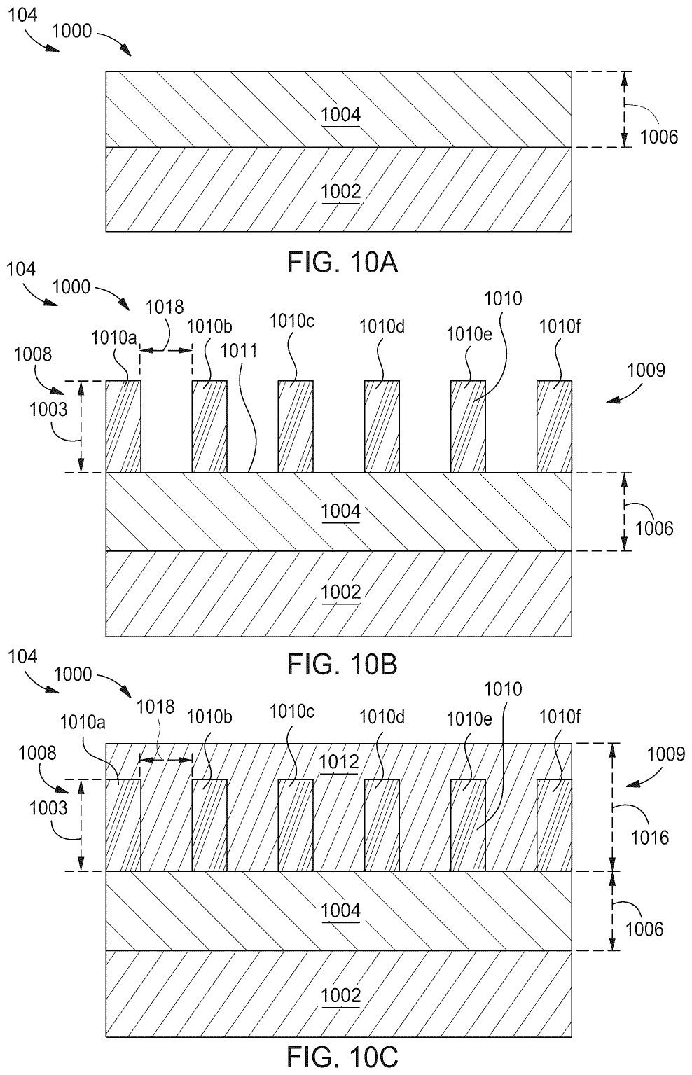

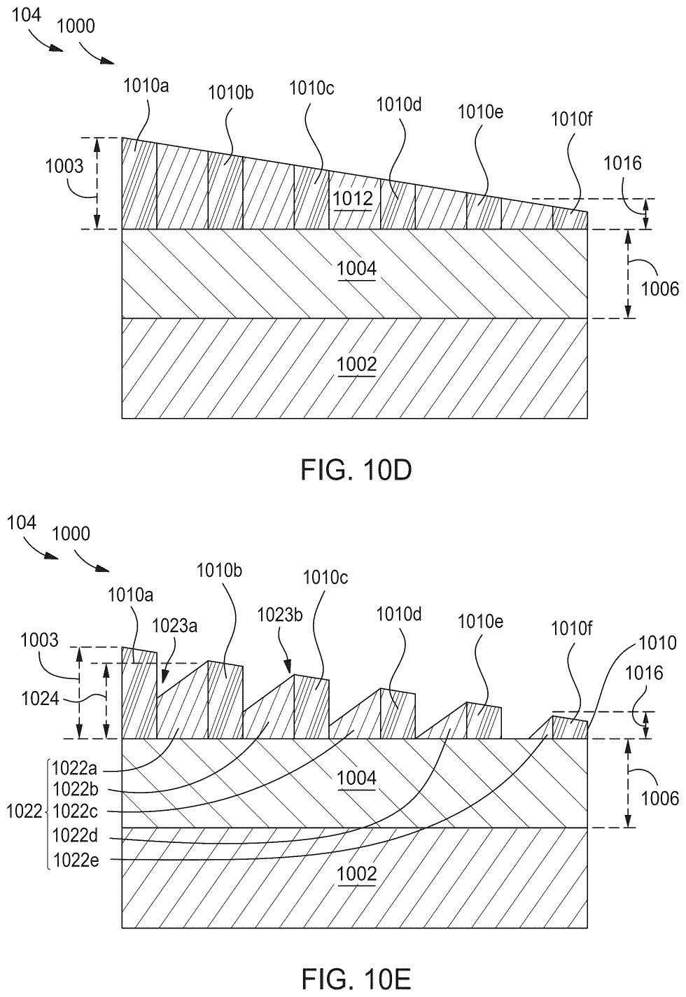

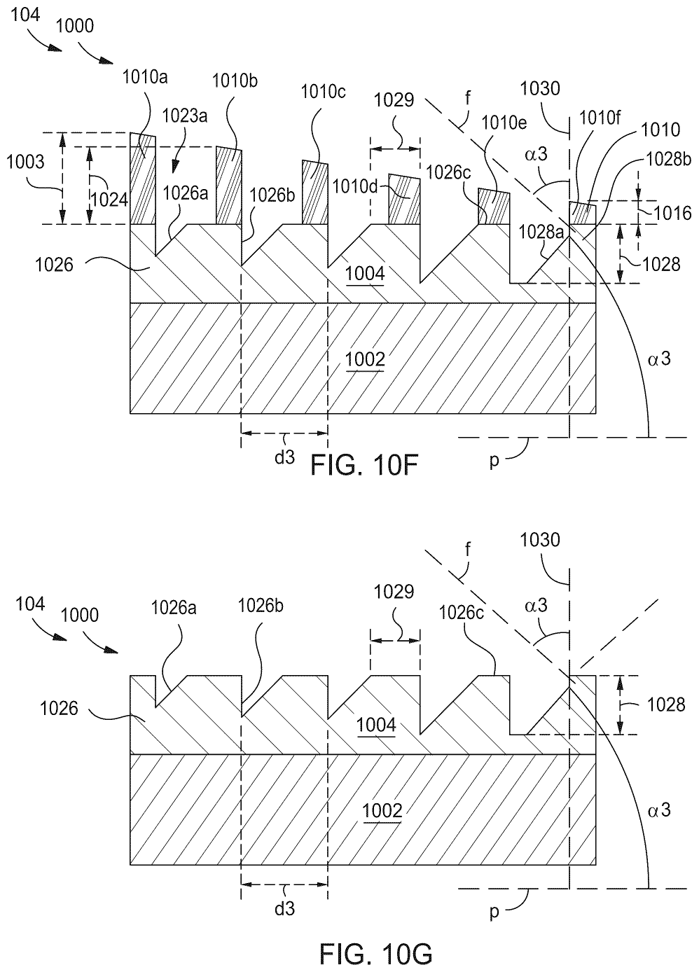

FIG. 9 illustrates a flow diagram of a method 900 for fabricating a waveguide combiner 100 according to one or more embodiments. FIGS. 10A-10G illustrate schematic, cross-sectional views of a grating 104 having a sixth configuration 1000 during a method 900 for fabricating a waveguide combiner 100 according to one or more embodiments. The method 900 forms third grating structures 1026 that are asymmetric. The grating height of the third grating structures 1026 change across the grating 104. One or more gratings 104, such as the first grating 104a and the second grating 104b may be formed according to the method 900.

At operation 902, and as illustrated in FIG. 10A, a grating 104 in a sixth configuration 1000 having a third grating layer 1004 formed over a third substrate 1002 is provided. In some embodiments, the third substrate 1102 may comprise the same material as waveguide substrate 101 described in FIG. 1. The third grating layer 1004 may be an optically transparent material, such as silicon oxide, silicon nitride, glass, TiO₂, or other material. The third grating layer 1004, may have an equal height across the entire third substrate 1002. For example, the third grating layer 1004 may have a fifth height 1006 that is consistent across the entire third substrate 1002.

At operation 904, and as illustrated in FIG. 10B, a first patterned hardmask layer 1008 is disposed over the third grating layer 1004. The first patterned hardmask layer 1008 may be made from any suitable hardmask material including but not limited to titanium nitride (TiN). The first patterned hardmask layer 1008 includes a hardmask material 1009 that is patterned to form patterned hardmask structures 1010 disposed over the third grating layer 1004. The first patterned hardmask layer 1008 may be patterned to form exposed portions 1011 of the third grating layer 1004. The first patterned hardmask layer 1008 may be patterned so a desirable quantity of grating structures may be formed in the third grating layer 1004. In or more one embodiments, the first patterned hardmask layer 1008 may include a first hardmask structure 1010a, a second hardmask structure 1010b, a third hardmask structure 1010c, a fourth hardmask structure 1010d, fifth hardmask structure 1010e, and a sixth hardmask structure 1010f. In one or more embodiments, the patterned hardmask structures 1010 may each have an equal hardmask structure height 1003 and may each be separated by a third horizontal distance 1018. In other embodiments, the patterned hardmask structures 1010 may each have a varying hardmask structure height 1003 across the third substrate 1002.

At operation 906, and as illustrated in FIG. 10C, a second hardmask layer 1012 is deposited over the first patterned hardmask layer 1008. The second hardmask layer 1012 is selected based on the chemistry on the third grating layer 1004 and the first patterned hardmask layer 1008. The second hardmask layer 1012 is deposited between and over the patterned hardmask structures 1010 and covers the exposed portions 1011. In one or more embodiments, the second hardmask layer 1012 is deposited with a sixth height (hardmask height) 1016 that is the same (consistent) across the entire third substrate 1002. In one or more embodiments, if the patterned hardmask structures 1010 each have a varying hardmask structure height 1003 operation 906 may be skipped.

At operation 908, and as illustrated in FIG. 10D, the first patterned hardmask layer 1008 and the second hardmask layer 1012 are etched using a third etching process. The first patterned hardmask layer 1008 and the second hardmask layer 1012 are etched such that the sixth height 1016 and the hardmask structure height 1003 change (vary) across the third substrate 1002. The first patterned hardmask layer 1008 and the second hardmask layer 1012 are etched so that the hardmask structure height 1003 and the sixth height 1016 change in same manner across the third substrate 1002. In one or more embodiments, the first patterned hardmask layer 1008 and the second hardmask layer 1012 are etched at the same etch rate. As noted above the second hardmask layer 1012 is selected based on the chemistry on the third grating layer 1004 and the first patterned hardmask layer 1008. The first patterned hardmask layer 1008 and the second hardmask layer 1012 are different materials with similar etching rates. The etching rates of the first patterned hardmask layer 1008 and the second hardmask layer 1012 are tuned to be the same by tuning the etch recipe of the third etching process. Stated otherwise, the hardmask structure height 1003 and the sixth height 1016 both increase (or decrease) across the third substrate 1002. For example, as illustrated in FIG. 10D, the first patterned hardmask layer 1008 and the second hardmask layer 1012 are etched so that the hardmask structure height 1003 and the sixth height 1016 decrease from the first side 1002a to the second side 1002b of the third substrate 1002 (or vice versa). In one or more embodiments, the hardmask structure height 1003 and sixth height 1016 are equal to each other across the third substrate 1002. In one or more embodiments, if the patterned hardmask structures 1010 each already have a varying hardmask structure height 1003, the second patterned hardmask layer 1202 may be directly depositing using an ink-jet process such that the hardmask structure height 1003 and the sixth height 1016 are equal to each other across the third substrate 1002 (i.e., without etching) and operation 908 may be skipped.

At operation, 910, and as illustrated in FIG. 10E, the second hardmask layer 1012 is etched using a fourth etching process. The fourth etching process may be an angled etching process that is selective to the first patterned hardmask layer 1008 due to the differences in materials of the second hardmask layer 1012 and the first patterned hardmask layer 1008. The fourth etching process may remove portions of the second hardmask layer 1012 to form slanted hardmask structures 1022 between each of the patterned hardmask structures 1010. A first slanted hardmask structure 1022a may be formed between the first hardmask structure 1010a and the second hardmask structure 1010b. A second slanted hardmask structure 1022b may be formed between the second hardmask structure 1010b and the third hardmask structure 1010c. A third slanted hardmask structure 1022c may be formed between the third hardmask structure 1010c and the fourth hardmask structure 1010d. A fourth slanted hardmask structure 1022d may be formed between the fourth hardmask structure 1010d and the fifth hardmask structure 1010e. A fifth slanted hardmask structure 1022f may be formed between the fifth hardmask structure 1010e and the sixth hardmask structure 1010f.

Each slanted hardmask structure 1022 may have a first end 1023a and a second end 1023b. Each slanted hardmask structure 1022 may have a slanted hardmask structure height 1024. The slanted hardmask structure height 1024 of the slanted hardmask structures 1022 increases (or decreases) from a first end 1023a to a second end 1023b of the slanted hardmask structures 1022. In one embodiment, the slanted hardmask structure height 1024 of each subsequent slanted hardmask structure 102a from the first side 1002a to the second side 1002b has a decreasing overall slanted hardmask structure height 1024 (or vice versa). For example, the slanted hardmask structure height 1024 at the second end 1023b of the first slanted hardmask structure 1022a is greater than the slanted hardmask structure height 1024 at the second end 1023b of the second slanted hardmask structure 1022b. Stated otherwise, because the first slanted hardmask structure 1022a includes a higher amount of photoresist than the second slanted hardmask structure 1022b, prior to the fourth etching process, the first slanted hardmask structure 1022a will have a greater slanted hardmask structure height 1024 than the second slanted hardmask structure 1022b at any corresponding point of the first slanted hardmask structure 1022a. The same applies between the second slanted hardmask structure 1022b and the third slanted hardmask structure 1022c, the third slanted hardmask structure 1022c and the fourth slanted hardmask structure 1022d, and so on (or vice versa). In some examples, portions of the slanted hardmask structures 1022 that are closer to the second side 1002b may be completely etched away due to their smaller slanted hardmask structure height 1024 prior to the fourth etching process. Advantageously, the slanted shape of the slanted hardmask structures 1022 and the changing slanted hardmask structure height 1024 allows the slanted hardmask structures 1022 to be used as an etch mask to form asymmetric gratings.

At operation 1112, and as illustrated in FIG. 10F, third grating structures 1026 are formed in the third grating layer 1004. The third grating structures 1026 have a first sidewall 1026a and a second sidewall 1026b, third grating height 1028, a top surface 1026c having a top width 1029, and a third linewidth d3. The third grating height 1028 is equal to the height of the second sidewall 1026b. The third linewidth d3 is equal to the distance between the first sidewall 1026a and the second sidewall 1026b of the third grating structures 1026. The second sidewall 1026b may have a blazed surface. The second sidewall 1026b has a third blaze angle α3. The third blaze angle α3 is the angle between a surface normal 1030 of the third substrate 1002 and facet normal f of the second sidewall 1026b. The third grating structures 1026 are formed by etching the third grating layer 1004 using the slanted hardmask structures 1022 as an etch mask. Stated otherwise, the third grating height 1028 may be defined as the depth of the grating material removed (etched) to form the corresponding third grating structures 1026. Due to the slanted shape of each slanted hardmask structure 1022 and the changing slanted hardmask structure height 1024, the third grating structures 1026 have a blaze shape (profile) with a varying third grating height 1028. For example, because the overall slanted hardmask structure height 1024 decreases from the first side 1002a to the second side 1002b the third grating height 1028 will decrease from the first side 1002a to the second side 1002b (or vice versa). During operation 1112, the slanted hardmask structures 1222 are removed. In some embodiments, all or some (i.e., a portion) of the third grating heights 1028 may vary across the third substrate 1002. Although the third grating heights 1028 are described as increasing or decreasing across the third substrate 1002, all or some of the third grating heights 1028 may vary in any combination across the third substrate 1002.

At operation 914 and as illustrated in FIG. 10G, the first patterned hardmask layer 1008 is removed using a dry etch process, a wet etch process, or any other suitable etch process.

While the foregoing is directed to embodiments of the present disclosure, other and further embodiments of the disclosure may be devised without departing from the basic scope thereof, and the scope thereof is determined by the claims that follow.

What is claimed is:

1. A waveguide combiner, comprising:
a substrate;
a grating disposed within or over the substrate and comprising a plurality of grating structures, each of the grating structures comprising:
a top surface having a top width;
a first sidewall, each first sidewall of each of the grating structures having a grating height, the grating height of the first sidewall of a portion of the grating structures varies across the substrate; and
a second sidewall opposing the first sidewall, the second sidewall having a blazed surface; and
a linewidth disposed between the first sidewall and the second sidewall.

2. The waveguide combiner of claim 1, wherein the blazed surface includes at least one step.

3. The waveguide combiner of claim 2, wherein the blazed surface of each of the grating structures include an equal quantity of steps.

4. The waveguide combiner of claim 2, wherein the blazed surface of a subset of the grating structures include a different quantity of steps.

5. The waveguide combiner of claim 2, wherein the top width of a subset of each of the grating structures is different.

6. The waveguide combiner of claim 2, wherein a subset of the grating structures have a same top width.

7. The waveguide combiner of claim 1, wherein the grating structures have a same linewidth.

8. The waveguide combiner of claim 1, wherein a subset of the grating structures have a different linewidth.

9. The waveguide combiner of claim 1, wherein the substrate comprises at least one of: glass, silicon (Si), silicon dioxide (SiO₂), germanium (Ge), silicon germanium (SiGe), indium phosphide (InP), gallium arsenide (GaAs), gallium nitride (GaN), fused silica, quartz, sapphire (Al₂O₃), silicon carbide (SiC), lithium niobate (LiNbO₃), or indium tin oxide (ITO).

10. The waveguide combiner of claim 1, wherein the grating structures comprise at least one of: silicon oxycarbide (SiOC), titanium dioxide (TiO₂), silicon dioxide (SiO₂), vanadium (IV) oxide (VOx), aluminum oxide (Al₂O₃), aluminum-doped zinc oxide (AZO), indium tin oxide (ITO), tin dioxide (SnO₂), zinc oxide (ZnO), tantalum pentoxide (Ta₂O₅), silicon nitride (Si₃N₄), zirconium dioxide (ZrO₂), niobium oxide (Nb₂O₅), cadmium stannate (Cd₂SnO₄), or silicon carbon-nitride (SiCN) containing materials.

11. A method comprising:
forming a slanted photoresist layer over a grating layer disposed over a substrate having a first side opposing a second side, the slanted photoresist layer having a first height that varies from the first side to the second side of the substrate and the grating layer is disposed with a second height that is consistent from the first side to the second side of the substrate;
forming a slanted grating layer by etching the grating layer using the slanted photoresist layer as an etch mask to cause the second height to vary from the first side to the second side of the substrate; and
forming grating structures by etching the slanted grating layer, each of the grating structures having a grating height, the grating height of a portion of the grating structures varies across the substrate.

12. The method of claim 11, wherein forming the slanted photoresist layer comprises:
depositing a photoresist layer over the grating layer, the photoresist layer is deposited with the first height being consistent from the first side to the second side of the substrate; and
patterning the photoresist layer to cause the first height to vary from the first side to the second side.

13. The method of claim 12, wherein the patterning of the photoresist layer causes the first height to decrease from the first side to the second side of the substrate.

14. The method of claim 13, wherein the second height decreases from the first side to the second side of the substrate.

15. The method of claim 14, wherein the grating height of each of the grating structures decreases from the first side to the second side of the substrate.

16. The method of claim 12, wherein the photoresist layer is patterned using a grey-tone lithography process.

17. The method of claim 11, wherein forming the slanted photoresist layer comprises depositing a slanted sacrificial hardmask layer directly on the grating layer using an ink-jet process.

18. The method of claim 11, wherein the substrate comprises at least one of: glass, silicon (Si), silicon dioxide (SiO₂), germanium (Ge), silicon germanium (SiGe), indium phosphide (InP), gallium arsenide (GaAs), gallium nitride (GaN), fused silica, quartz, sapphire (Al₂O₃), silicon carbide (SiC), lithium niobate (LiNbO₃), or indium tin oxide (ITO).

19. The method of claim 11, wherein the grating structures comprise at least one of: silicon oxycarbide (SiOC), titanium dioxide (TiO₂), silicon dioxide (SiO₂), vanadium (IV) oxide (VOx), aluminum oxide (Al₂O₃), aluminum-doped zinc oxide (AZO), indium tin oxide (ITO), tin dioxide (SnO₂), zinc oxide (ZnO), tantalum pentoxide (Ta₂O₅), silicon nitride (Si₃N₄), zirconium dioxide (ZrO₂), niobium oxide (Nb₂O₅), cadmium stannate (Cd₂SnO₄), or silicon carbon-nitride (SiCN) containing materials.

20. A method comprising:
forming grating structures in a grating layer disposed over a substrate having a first side opposing a second side, the grating structures each having a grating height, the grating height is the same from the first side to the second side of the substrate;
forming a slanted photoresist layer over the grating structures having a height that varies from the first side to the second side of the substrate; and
etching the grating structures using the slanted photoresist layer as an etch mask, the etching of the grating structures causing the grating height of a portion of the grating structures to vary from the first side to the second side of the substrate.
